(19) United States
(12) Patent Application Publication
(10) Pub. No.: US 2006/0289118 A1
(43) Pub. Date: Dec. 28, 2006

(54) Magnetic tape dispenser

(75) Inventor: Lee Yi-Ju, Taipei (TW)

Correspondence Address: LAW OFFICES OF CLEMENT CHENG, 17220 NEWHOPE STREET #127, FOUNTAIN VALLEY, CA, 92708, US

(73) Assignee: JASDI MAGNET CO., LTD.

(21) Appl. No.: 11/166,015

(22) Filed: Jun. 24, 2005

(51) Int. Cl. B32B 37/00; B44C 7/00

(52) U.S. Cl. 156/577; 156/523

(57) ABSTRACT

This is one type of plastic magnetic tape dispenser, the main purpose of which is to eliminate the current inconvenience of having to peel off the removable film that is associated with the plastic magnetic tape: It is a case with an opening; on the inner side of the opening is a turner; along the edge is a cutter; within the case is a receiving/releasing assembly which consists of a receiving device and a releasing device, which are set on separate axis and turn interactively. There is a plastic magnetic tape; the two ends of which, with the removable film on the underside, are wrapped around the receiving device and the releasing device, respectively. One end of the plastic magnetic strip separates from the removable film at the turner and sticks out of the opening. When using this invention, pull the plastic magnetic strip out of the opening and adhere it and then cut it with the cutter. Because the receiving device, which turns interactively with the releasing device, is pulling the removable film inward, this invention is ease to use and offers the benefit of obviating the need for a separate cutting action.

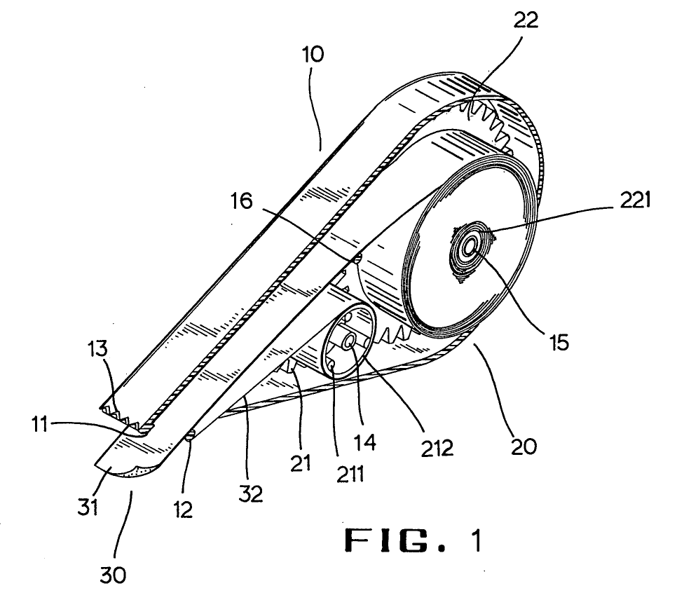

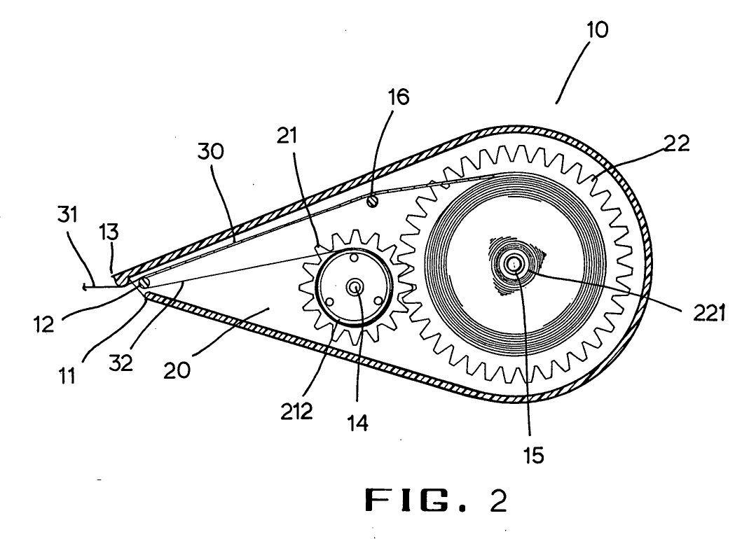

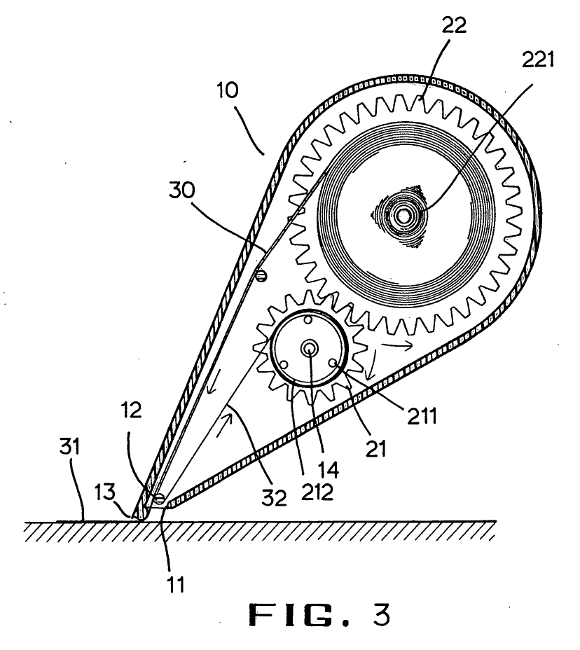

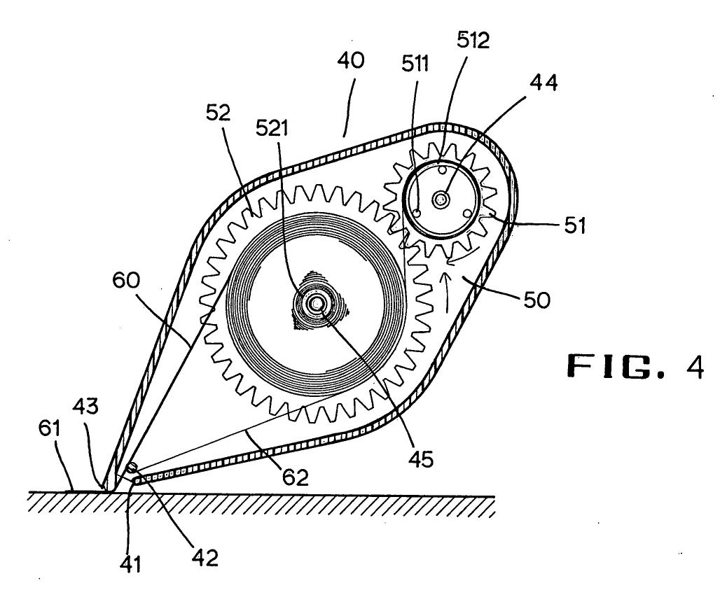

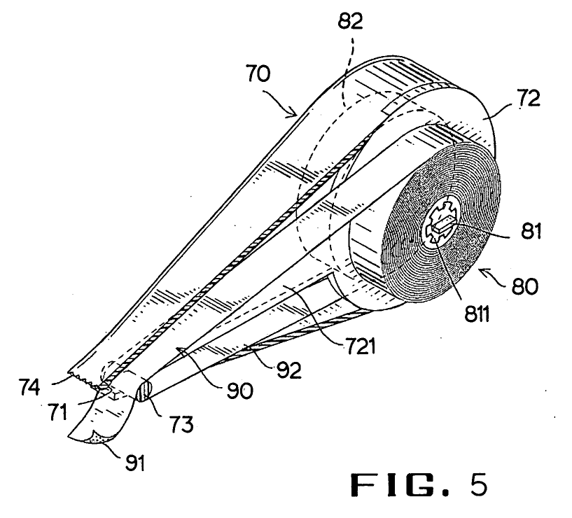

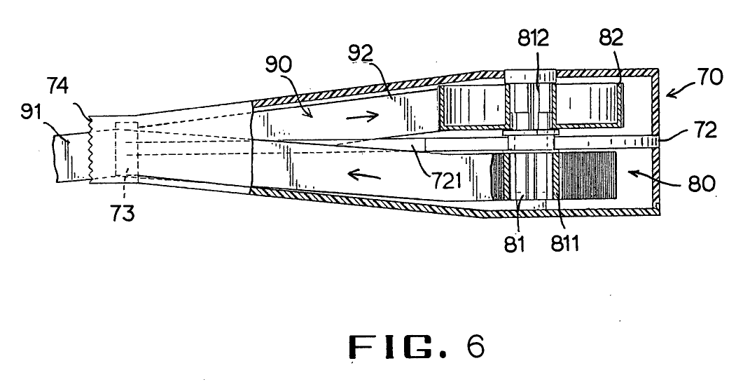

### FIELD OF THE INVENTION

This invention involves an assembly that makes it easy to apply plastic magnetic tapes. It particularly refers to a plastic magnetic tape releasing/receiving assembly that offers ease of use with a releasing and receiving design. Note: This invention does not relate to magnetic data storage tape but rather magnetic strips commonly used for signage.

### DISCUSSION OF RELATED ART

The existing plastic magnetic tape consists of a plastic magnetic strip with cement on the underside (of the plastic magnetic strip) and a removable film that is stuck to the cement surface of the plastic magnetic tape. The plastic magnetic tape possesses magnetic quality; the plastic magnetic tape is rolled up in a reel for storage.

When the plastic magnetic tape needs to be used, one end of the plastic magnetic tape is pulled out and a piece of the desired length is cut. The removable film is peeled off from that section of the plastic magnetic strip and the plastic magnetic strip is applied to the area where it is needed; or, it is used to hold memos in place by sticking it up as a magnet, or, it is used to pick up and hold small metal objects, such as paper clips.

Nevertheless, this way of using the plastic magnetic tape is indeed bothersome because it requires the use of a knife to cut the desired length and it requires the process of peeling off the removable film. The peeling off of the removable film particularly requires a relatively larger expenditure of attentiveness and time. Furthermore, there is the need to locate the trash bin to dispose of the removable film after it is peeled off. As a result, extra burden is caused in the process of use. To enhance the ease of use, improvement is a must.

### BRIEF DESCRIPTION OF THE DRAWINGS

Diagram 1 is a partial three dimensional cross-section view of the first of the better modes of execution of this invention.

Diagram 2 is cross-section view of the first of the better modes of execution of this invention.

Diagram 3 is a diagram of the first of the better modes of execution of this invention.

Diagram 4 is a diagram of the second of the better modes of execution of this invention.

Diagram 5 is a partial three dimensional cross-section view of the third of the better modes of execution of this invention.

Diagram 6 is a three-dimensional top view of the third of the better modes of execution of this invention.

### SUMMARY OF THE INVENTION

In view of the current annoying shortcomings that associate with the use of plastic magnetic tapes, this invention, which is a plastic magnetic tape delivery assembly, solves the aforementioned problem with a receiving/releasing design and achieves the benefit of ease of use.

To achieve the purpose, this invention consists of:

A case that has an opening; on the inner side of the opening is a turner; along the edge of the opening is a cutter;

A receiving/releasing assembly which is set inside the case and is consisted of a receiving device and a releasing device, which are set on separate axis and turn interactively; and

A plastic magnetic tape, which is made up of a plastic magnetic strip with cement on the underside (of the plastic magnetic strip) and a relatively longer removable film that is stuck to the plastic magnetic tape; with the removable film on the underside, the tape goes around the outer side of the turner and the two ends of the plastic magnetic tape wrap around the receiving device and the releasing device, respectively. Only the removable film rolls onto the receiving device; the end of the plastic adhesive piece that is on the inside is at the turner and it sticks out of the opening.

Further definition of three modes of execution of this invention:

Mode One, the inside of the case is fitted with a receiving post and a releasing post; the receiving post is in closer proximity to the opening; between the receiving post and the releasing post, but on the side closer to the cutter, there is a guiding post; the receiving device is a toothed dish that has three posts arranged in a triangular formation in the center on one end and it is placed around the receiving post; surrounding the three posts is a ring. The releasing device is a toothed dish with a cylinder on one end; it is placed around the releasing post and it, i.e., the releasing device, meshes with the receiving device. One end of the plastic magnetic tape wraps around the ring of the receiving device from the side near the cutter; the other end of the plastic magnetic tape, with its underside against the guiding post, wraps around the cylinder of the releasing device from the side closer to the cutter.

Mode Two, the inside of the case is fitted with a receiving post and a releasing post; the releasing post is closer to the opening. The receiving device is a toothed dish that has three posts arranged in a triangular formation in the center on one end and it is placed around the receiving post; surrounding the three posts is a ring. The releasing device is a toothed dish with a cylinder on one end; it is placed around the releasing post and it meshes with the receiving device. One end of the plastic magnetic tape wraps around the ring of the receiving device from the side near the cutter; the other end of the plastic magnetic tape wraps around the cylinder of the releasing device from the side closer to the cutter; the portion of the tape between the receiving device and the turner goes around the releasing device on the side away from the cutter.

Mode Three, a separating panel is set inside the case. The receiving device is an axis that goes through the axis of the separating panel and forms into an over-capping cylinder on one end. The releasing device is a ring which is placed over the other end of the receiving device that does not have an over-capping cylinder. One end of the plastic magnetic tape wraps around the over-capping cylinder of the receiving device on the side that is close to the cutter; the other end wraps around the ring of the releasing device from the side away from the cutter.

When using this invention, pull the plastic magnetic strip out of the opening and adhere it to where adhesion is desired, then, pull the case backward, and then sever the plastic magnetic strip with the cutter. When the plastic magnetic tape is being pulled out, the receiving device, which turns interactively with the releasing device, simultaneously reels in the removable film. In this design, the circulatory driving force for the plastic magnetic tape comes from pulling and turning of the releasing device by the plastic magnetic strip. However, because the movements of the releasing device and the receiving device are not identical, compensation is provided with through the ring of the receiving device and the gliding of the various posts; therefore, when the receiving device turns excessively, the various posts and the ring will attain corresponding gliding thereby achieving a balanced receipt and release between the releasing device and the receiving device.

In this invention, the length of the plastic magnetic strip is determined by the amount of tape being pulled and then it, i.e., the strip, is cut by using the cutter. There is no need to separately pre-cut the desired length with a knife, which means the user can freely determine the length of the strip as he see fits. Furthermore, the retrieval of the peeled-off removable film is easy and requires no extra attention or efforts, neither is there a need to divert attention to the disposal of the peeled-off removable film that has been retrieved.

### DETAILED DESCRIPTION OF THE PREFERRED EMBODIMENTS

This is one type of plastic magnetic tape dispenser; please refer to Diagrams 1 to 3 for the first of the better modes of execution, which includes:

A case (10), the case (10) is a flat tear-drop shaped box with an opening (11) at the pointed tip, on the inner side of the opening (11) is a tubular turner (12) that runs across from one side to the opposing side, at the edge of the opening (11) on the case (10) is placed a sharp-edged cutter (13), inside the case (10) is set a receiving post (14) with a parallel turner (12); releasing post (15) of the parallel turner (12); the receiving post (14) is closer to the opening (11); the receiving post (14) is in closer proximity to the opening (11); between the receiving post (14) and the releasing post (15), but on the side closer to the cutter (13), there is placed a guiding post (16).

A receiving/releasing assembly (20) which is set inside the case (10) and is consisted of a receiving device (21) and a releasing device (22); the receiving device (21) is a toothed dish that has three posts (211) arranged in a triangular formation in the center on one end and it is placed around the receiving post (14); surrounding the three posts (211) is a circular ring (212). The releasing device (22) is a toothed dish with a round cylinder (221) on one end; it is placed around the releasing post (15) and it i.e., the releasing device meshes with the receiving device (21).

A plastic magnetic tape (30), which is made up of a plastic magnetic strip (31) with cement on the underside of the plastic magnetic strip and a relatively longer removable film (32) which is stuck to the plastic magnetic tape; with the removable film (32) on the underside, the tape goes around the outer side of the turner (12) and the two ends of the plastic magnetic tape wrap around the receiving device (21) and the releasing device (22), respectively. One end of the plastic magnetic tape (30) wraps around the ring (212) of the receiving device (21) from the side near that cutter (13); the other end of the plastic magnetic tape wraps around the cylinder (221) of the releasing device (22) from the side closer to the cutter (13). Only the removable film (32) rolls onto the ring (212) of the receiving device (21); the underside of the plastic adhesive tape (30) that is in the area between the turner (12) and the releasing device (22) touches the guiding post (16); and the plastic magnetic strip (31) inside is at the turner (12) and it sticks out of the opening (11).

Please refer to Diagram 4 for the second of the better modes of execution, which includes:

A case (40), the case (40) is a diamond shaped box with an opening (41) at the pointed tip, on the inner side of the opening (41) is a tubular turner (42) that runs across from one side to the opposing side, at the edge of the opening (41) on the case (40) is placed a sharp-edged cutter (43), inside the case (40) is set a receiving post (44) with a parallel turner (42) and a releasing post (45) of the parallel turner (42); the releasing post (45) is closer to the opening (41).

A receiving/releasing assembly (50) which is set inside the case (40) and is consisted of a receiving device (51) and a releasing device (52); the receiving device (51) is a toothed dish that has three posts (511) arranged in a triangular formation in the center on one end and it is placed around the receiving post (44); surrounding the three posts (511) is a circular ring (512). The releasing device (52) is a toothed dish with a round cylinder (521) on one end; it is placed around the releasing post (45) and it i.e., the releasing device meshes with the receiving device (51).

A plastic magnetic tape (60), which is made up of a plastic magnetic strip (61) with cement on the underside of the plastic magnetic strip and a relatively longer removable film (62) which is stuck to the plastic magnetic tape; with the removable film (62) on the underside, the tape goes around the outer side of the turner (42) and the two ends of the plastic magnetic tape wrap around the receiving device (51) and the releasing device (52), respectively. One end of the plastic magnetic tape (60) wraps around the ring (512) of the receiving device (51) from the side near that cutter (43); the other end of the plastic magnetic tape wraps around the cylinder (521) of the releasing device (52) from the side closer to the cutter (43). Only the removable film (62) rolls onto the ring (512) of the receiving device (51); the portion of the plastic adhesive tape (60) that is in the area between the receiving device (51) and the turner (42) goes around the releasing device (52) on the side near from the cutter (43); the end of the plastic adhesive piece (61) that is on the inside is at the turner (42) and it sticks out of the opening (41).

Please refer to Diagrams 5 and 6 for the third of the better modes of execution, which includes:

A case (70), the case (70) is a tear-drop shaped box with an opening (71) at the pointed tip. Between the case (70) and the opposing walls is set a separating panel (72); the separating panel (72) extends to the opening (71) and forms a connecting panel (721); the external end of the connecting panel (721) is located on the inside of that opening (71). There is a tubular turner (73) for the vertical separating panel (72). A sharp-edged cutter (74) is placed on one side of the edge of that opening (71).

A receiving/releasing assembly (80) which is set inside the case (70) and is consisted of a receiving device (81) and a releasing device (82); the receiving device (81) is a tubular axis that goes through the axis of the separating panel (72) and forms into an over-capping cylinder (811) on one end; on the surface of the other end are several cutting furrows (812). The releasing device (82) is a circular ring and is placed around the end of the receiving device (81) where there are several cutting furrows (812); through coupling with the part of the receiving device (81) where there are several cutting furrows (812) a gliding union is achieved.

A plastic magnetic tape (90), which is made up of a plastic magnetic strip (91) with cement on the underside of the plastic magnetic strip and a relatively longer removable film (92) which is stuck to the plastic magnetic tape; with the removable film (92) on the underside, the tape goes around the outer side of the turner (82) and the two ends of the plastic magnetic tape wrap around the receiving device (81) and the releasing device (82), respectively. One end of the plastic magnetic tape (90) wraps around the cylinder (811) of the receiving device (81) from the side close to the cutter (74); the other end of the plastic magnetic tape wraps around the outer perimeter of the releasing device (82) from the farther side of that cutter (74); the end of the plastic adhesive piece (91) which is on the inside is at the turner (73) and it sticks out of the opening (71).

For a detailed picture of the execution of this invention, please refer to Diagram 3. Using the first of the better modes of execution as an example: Pull one end of the plastic magnetic tape (30) out of the opening (11), adhere it to where adhesion is desired, then, pull the case (10) backward so as to allow the plastic magnetic tape (30) to be pulled out from the releasing device (22) through the opening to the desired length and that the plastic magnetic tape (30) and the removable film (32) are separated at the turner (12). Next, sever the plastic magnetic strip (31) with the cutter (13). Because the receiving device (21), which turns interactively with the releasing device (32), simultaneously reels in the removable film (32) when the plastic magnetic strip (31) is being pulled out, this invention may be pulled and used continuously and repeatedly and provides the advantage of ease of use.

An explanation of the symbols of the main parts

| | | | |
|---|---|---|---|
| (10) | Case | (11) | Opening |
| (12) | Turner | (13) | Cutter |
| (14) | Receiving post | (15) | Releasing post |
| (16) | Guiding post | (20) | Receiving/receiving device |
| (21) | Receiving device | (211) | Post |
| (212) | Ring | (22) | Releasing device |
| (221) | Cylinder | (30) | Plastic magnetic tape |
| (31) | Plastic magnetic strip | (32) | Removable film |
| (40) | Case | (41) | Opening |
| (42) | Turner | (43) | Cutter |
| (44) | Receiving post | (45) | Releasing post |
| (50) | Receiving/releasing | (51) | Receiving device |
| | assembly | | |
| (511) | Post | (512) | Ring |
| (52) | Releasing device | (521) | Cylinder |
| (60) | Plastic magnetic tape | (61) | Plastic magnetic strip |
| (62) | Removable film | (70) | Case |
| (71) | Opening | (72) | Separating panel |
| (721) | Connecting panel | (73) | Turner |
| (74) | Cutter | (80) | Receiving/releasing assembly |
| (81) | Receiving device | (811) | Cylinder |
| (812) | Cutting furrow | (82) | Releasing device |
| (90) | Plastic magnetic tape | (91) | Plastic magnetic strip |
| (92) | Removable film | | |

### CALL OUT LIST

| | | | |
|---|---|---|---|
| (10) | Case | (11) | Opening |
| (12) | Turner | (13) | Cutter |
| (14) | Receiving post | (15) | Releasing post |
| (16) | Guiding post | (20) | Receiving/receiving device |
| (21) | Receiving device | (211) | Post |
| (212) | Ring | (22) | Releasing device |
| (221) | Cylinder | (30) | Plastic magnetic tape |
| (31) | Plastic magnetic strip | (32) | Removable film |

1. A plastic magnetic tape dispensing assembly, comprising:
a case having an opening;
a turner inside the opening;
a cutter along the edge of the opening;
a receiving releasing assembly which is set inside the case and is made of a receiving device and a releasing device, which are set on separate axes and turn interactively; and
a plastic magnetic tape, which is made up of a plastic magnetic strip with adhesive on the underside of the plastic magnetic strip covered by a removable film in the shape of a strip on the underside and stuck to the plastic magnetic tape;
wherein as the tape goes around the outside of the turner, only the removable film rolls onto the receiving device whereby an end of the plastic magnetic strip sticks out of the opening for application to articles.

2. The plastic magnetic tape dispensing assembly as described in claim 1, wherein the inside of the case is fitted with a receiving post and a releasing post; the receiving post is in closer proximity to the opening; wherein between the receiving post and the releasing post, but on the side closer to the cutter, there is a guiding post; wherein the receiving device is a toothed dish that has three posts arranged in a triangular formation in the center on one end and it is placed around the receiving post; wherein surrounding the three posts is a ring, wherein the releasing device is a toothed dish with a cylinder on one end; wherein the releasing device is placed around the releasing post and meshes with the receiving device, wherein one end of the plastic magnetic tape wraps around the ring of the receiving device from the side near the cutter; and the other end of the plastic magnetic tape, with its underside against the guiding post, wraps around the cylinder of the releasing device from the side closer to the cutter.

3. The plastic magnetic tape dispensing assembly as described in claim 1, wherein the inside of the case is fitted with a receiving post and a releasing post; wherein the releasing post is closer to the opening; wherein receiving post is in closer proximity to the opening; wherein the receiving device is a toothed dish that has three posts arranged in a triangular formation in the center on one end and it is placed around the receiving post; wherein surrounding the three posts is a ring; wherein the releasing device is a toothed dish with a cylinder on one end; it is placed around the releasing post and it meshes with the receiving device; wherein one end of the plastic magnetic tape wraps around the ring of the receiving device from the side near the cutter; wherein the other end of the plastic magnetic tape wraps around the cylinder of the releasing device from the side closer to the cutter; wherein the portion of the tape between the receiving device and the turner goes around the releasing device on the side away from the cutter.

4. The plastic magnetic tape dispensing assembly as described in claim 1, further comprising a separating panel set inside the case wherein the receiving device is an axis that goes through the axis of the separating panel and forms into an over-capping cylinder on one end, wherein one end of the plastic magnetic tape wraps around the over-capping cylinder of the receiving device on the side close to the cutter; whereby the other end wraps around the ring of the releasing device from the side away from the cutter.

5. A plastic magnetic tape dispenser, comprising:
a case having an opening that is slot shaped;
a peeler near the opening;
a receiving releasing assembly which is set inside the case and is made of a receiving device and a releasing device, which are set on separate axes and turn interactively; and
a plastic magnetic tape, comprising a plastic magnetic strip with an adhesive underside covered by a removable film strip;
wherein as plastic magnetic tape travels around the outside of the peeler, the peeler removes the removable film which is rolled onto the receiving device whereby an adhesive exposed end of the plastic magnetic strip sticks out of the opening for application to articles.

6. A plastic magnetic tape dispenser, comprising:
a case having an opening that is slot shaped;
a peeler near the opening;
a receiving releasing assembly which is set inside the case and is made of a receiving device and a releasing device, which are set on colinear axes and turn interactively; and
a plastic magnetic tape, comprising a plastic magnetic strip with an adhesive underside covered by a removable film strip;
wherein as plastic magnetic tape travels around the outside of the peeler, the peeler removes the removable film which is rolled onto the receiving device whereby an adhesive exposed end of the plastic magnetic strip sticks out of the opening for application to articles.
